(19) United States
(12) Patent Application Publication
(10) Pub. No.: US 2005/0054410 A1
(43) Pub. Date: Mar. 10, 2005

(54) Occlusion device for gambing machine display elements

(76) Inventors: Joaquin Franco Munoz, Madrid (ES); Jesus Franco Munoz, Madrid (ES)

Correspondence Address: KRAMER & AMADO, P.C., 2001 JEFFERSON DAVIS HWY, SUITE 1101, ARLINGTON, VA, 22202, US

(21) Appl. No.: 10/484,099

(22) PCT Filed: May 29, 2002
(86) PCT No.: PCT/ES02/00256

(30) Foreign Application Priority Data
Jul. 16, 2001 (ES) U0101829

(51) Int. Cl. A63F 13/00

(52) U.S. Cl. 463/16

(57) ABSTRACT

It consists of an opaque blind (4) susceptible to covering part of the display (1) carrying the images (2) that are visible through the screen of the machine at the end of each play, for the purpose of temporarily hiding said images (2) to substitute them with others existing on the outer face of the blind (4). This blind (4) is associated to an arm (5) finished off with a ring (6) assembled with rotational freedom on a support (10), said disc ring (6) having a gearing (7) through which it receives the movement from a micromotor (9) which makes the blind (4) rock between the operating and non-operating limit positions, duly defined by a pair of end stops (11-11′) or by the electronic control of a “stepper” type drive motor (9).

### OBJECT OF THE INVENTION

The present invention refers to an stopper that has been specially designed to temporarily hide the normally visible part of a display or rotating drum which are conventionally used in recreational gambling machines.

The object of the invention is to achieve keeping hidden one or more of the images which participate through said displays in the combination corresponding to a winning line during the development of the play, in turn keeping said combination partially hidden, which allows the player to choose different game alternatives before definitively concluding the play depending on the images he/she sees and those which the player expects that may exist on the hidden display or displays.

Thus, the invention is applicable to the field of recreational gambling machines with cash prizes and permits enhancing the services of the game with the direct intervention of the player in the results of each play.

### BACKGROUND OF THE INVENTION

In the practical field of application of the invention, that of recreational gambling machines with cash prizes, displays having a plurality of different images or figures are used, which sequentially appear on the screen of the machine in the development of each play, such that at the end of the play, the images corresponding to the different displays, established on a winning line, produce a determined combination that is susceptible to a prize according to a wining plan also suitable established on the screen of the machine.

These displays adopt multiple shapes and different types of actuation in practice, but they have the common denominator of showing only a portion of them through the screen of the machine, which are normally comprised by three of the previously mentioned figures, and occasionally part of the immediately prior and subsequent figures, such that in the end phase of the play, when the displays are stabilized, a series of figures are seen through them which regard those which can establish one or more horizontal lines immediately prior and subsequent to said figure, and also diagonal lines on occasion, so that when the figures of the valid winning line coincide at all times with one of the winning plan combinations, the machine gives the player the corresponding cash prize.

To date, the only possibility of increasing the chances of playing on this main group of machine displays consisted of establishing an auxiliary display, which in turn shows a figure and which, in determined circumstances, can be moved to any one of the displays of the winning line in order to substitute the figure of the latter, or to perform “advances” in the displays in order to equally modify the final combination.

### DESCRIPTION OF THE INVENTION

The stopper proposed by the invention constitutes and advancement in this line of permitting the player to have a greater intervention in the game, specifically by keeping at least one of the displays of the machine hidden during the development of the play, such that when said displays are stabilized, the player cannot completely visualize the combination he has obtained, and depending on the figures that he can visualize, they are shown to him and based on his own intuition regarding which figure can be hidden by the stopper lid, he is in conditions to choose determined game alternatives, in a manner relatively similar to how it occurs in open-hand poker, wherein while the majority of the cards are visible to the player, one or some of them are kept hidden.

To do so and more specifically, the stopper of the invention is made in a formally and dimensionally suitable blind so as to permit covering the entire part of the corresponding display, which in theory can be visualized through the screen of the machine, a blind preferably shaped in a cylindrical segment, having a curvature coinciding with that of the display, assembled with rotational freedom on a support, which in practice will preferably be assembled on the drive motor of the display, a support on which a small auxiliary motor is established which supplies the rotational movement to the blind within a determined angle established by a pair of end stops assembled with a stationary character on repeatedly said support and a stop acts on them which is associated to the blind, such that said end stops establish the opening and closing situation limits of said blind suitably controlled by said micromotor.

However, in practice, said motor can be materialized as a stepper motor, in which case said stop and end stops are unnecessary, the angular shift amplitude of the blind being controlled by means of the control in the angular movement of the motor.

The stopper of the invention will optionally incorporate on its outer surface, the one which is visible through the screen of the machine, additional figures and a window that is formally and dimensionally suitable for permitting seeing a figure present on the roller or drum of the gambling or recreational machine, such that the game alternatives are additionally increased.

On those occasions in which a volumetric reduction of the device is desired or necessary due to space availability problems or for any other reason, the use of a cylindrical capsule as support of the drive motor of the rotating display has been foreseen, which has an internal diameter suitable for that of said motor, but significantly over-dimensioned in the axial direction such that the space of said capsule not occupied by the main motor is intended for placing the drive micromotor of the lid and its corresponding reducing assembly, assembled on a disc shaped support like a pan, having a diameter corresponding to that of the main motor.

The output pinion of the reducing group significant protrudes in a radial direction with regard to the disc shaped support and passes through a window operatively made in the cylindrical capsule so as to mesh with the ring gear finishing off the arm of the stopper lid, which in this case has the geared movement transmission on its inner edge.

In this manner, the support of the drive means of the stopper lid is located inside of the support of the main motor of the display, therefore its volumetric occupation is minimal, involving practically no repercussion whatsoever on the volumetry of the display assembly with all its accessories.

In another variant of the embodiment of the invention, and if the intention is to facilitate both implanting and maintaining the stopper, the latter is structured as from a flywheel bearing the stopper blind, a flywheel intended to laterally and coaxially be adapted to the corresponding roller, maintaining the previously mentioned physical independence, but such that its blind is superimposed on the periphery of the roller and, depending on the position adopted by the flywheel, it is in turn able to hide or not hide the images of said roller facing the display window, for which purpose the repeatedly mentioned flywheel is assembled with rotational freedom on a support parallel to the roller support and which, like the latter, adopts an “L” shaped profile to be fixed by screwing it to the machine structure.

Said flywheel incorporates a perimetral gearing through which it receives the movement of a micromotor, established on the support itself, through a reducing transmission whose output pinion meshes with the perimetral gearing of the flywheel.

### DESCRIPTION OF THE DRAWINGS

In order to complement the description that is being given and for the purpose of helping to better understand the features of the invention according to a preferred practical embodiment example thereof, a set of drawings accompany said description as integral part thereof which, with an illustrative and non-limiting character, show the following:

FIG. 1.—Shows a perspective view of a disassembled stopper that is practicable for displays of gambling or recreational machines according to the object of the present invention, together with part of the corresponding display.

FIG. 2.—Shows a side elevational view of the duly assembled assembly from the previous figure.

FIG. 3.—Shows a section detail of the assembly shown in FIG. 2 according to the A-B cut line of said figure.

FIG. 4.—Shows a perspective view of a disassembled stopper that is practicable for displays of gambling or recreational machines according to the embodiment variant wherein additional figures as well as a viewing window are incorporated.

FIG. 5.—Shows a perspective view of a disassembled rotating display for a recreational machine provided with another embodiment variant for the stopper.

FIG. 6.—Finally shows a new embodiment variant of the stopper, also according to a perspective view, in which said stopper is disconnected from the corresponding display, but duly facing it.

### PREFERRED EMBODIMENT OF THE INVENTION

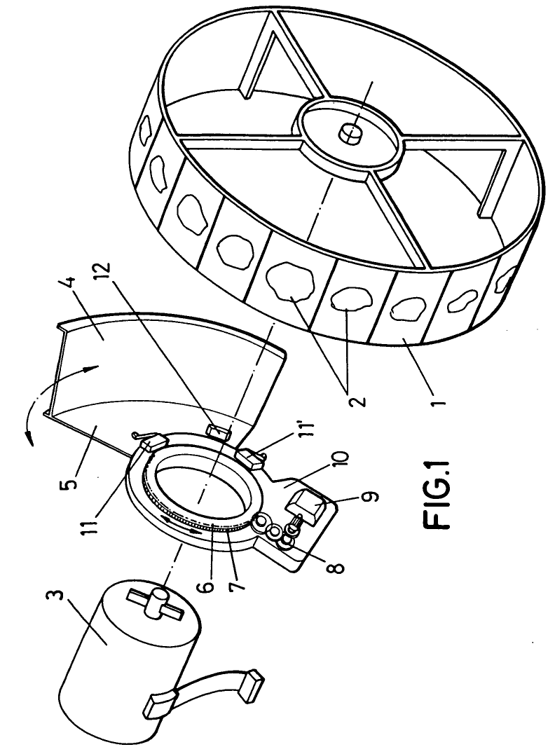

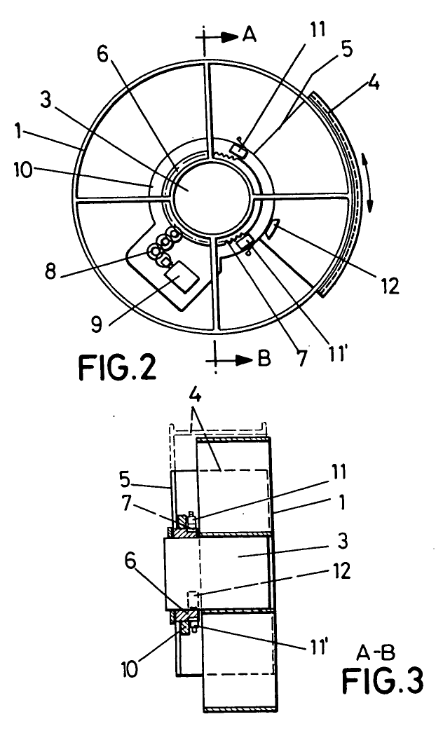

In view of said figures, specifically FIGS. 1 to 3, it can be seen how the stopper proposed by the invention, in the present case especially designed for displays (1) made in a cylindrical roulette or drum, carrying an alignment of images (2) on its periphery and driven by an electric motor (3) coaxially assembled on it, is materialized in a rectangular blind (4), having an arched profile, formally and dimensionally suitable so as to be placed outside and concentrically on the display (1), hiding the images or figures (2) of the latter, which must be visible through the screen, for which purpose, and as is evident, said blind (4) must be opaque, extending along one of its side edges in a radial arm (5) that on the other end is finished off with a disc ring (6), provided with a geared sector (7) on its edge, a ring (6) intended to be assembled with rotational freedom on the motor (3) of the drum or display (1) and to receive, through its gearing (7) and with the collaboration of a set of reducing gears (8), the movement generated by a micro-motor established, likewise with the set of gears (8), on an established support, likewise with the set of gears (8) on a support (10) that is suitably connected to the support of the main motor (3).

Said support (10) also constitutes the holding means for a suitably spaced pair of microswitches or end stops (11-11′), between which there is a stop (12) connected to the arm (5) of the blind (4), such that one of these end stops (11) establishes the closing limit situation for the blind, whereas the other one in turn establishes the opening limit situation.

As previously mentioned, the micromotor (9) can be the “stepper” type, in which case the microswitches or end stops (11-11′) as well as the stop (12) are unnecessary, since in this case the movement of the blind can be controlled by the temporization in the supply of said micromotor.

In any case, it is achieved that in the closing situation for the blind (4), the latter hides the figures (2) of the display (1) that would normally be visible through the screen of the machine so that the player only sees part of the figures participating in the combination that is susceptible to winning, in an order that the player can choose different types of plays or bets depending on his personal criterion, specifically on the existing possibilities that, in his point of view, the hidden figure completes a winning combination with the visible figures, the blind (4) being opened once the player has made the corresponding decision and has acted in consequence.

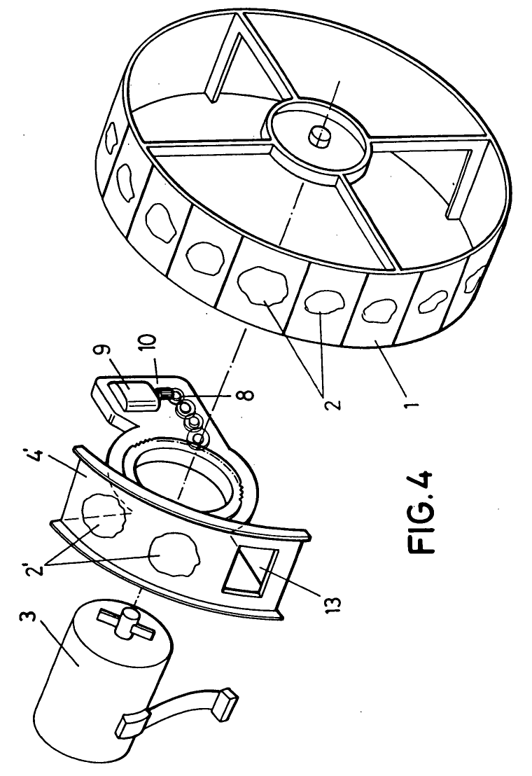

In the embodiment variant shown in FIG. 4, on the basis of the same structuring, the blind (4′) incorporates on its exterior surface, which is visible through the screen of the machine, additional figures (2′) that are complementary to the figures (2) present on the drum or roller (1), as well as a window (13) permitting visualizing said figures (2) of the drum or roller (1). Logically, the number of figures (2′) and windows (13) can vary in position and number depending on the corresponding needs.

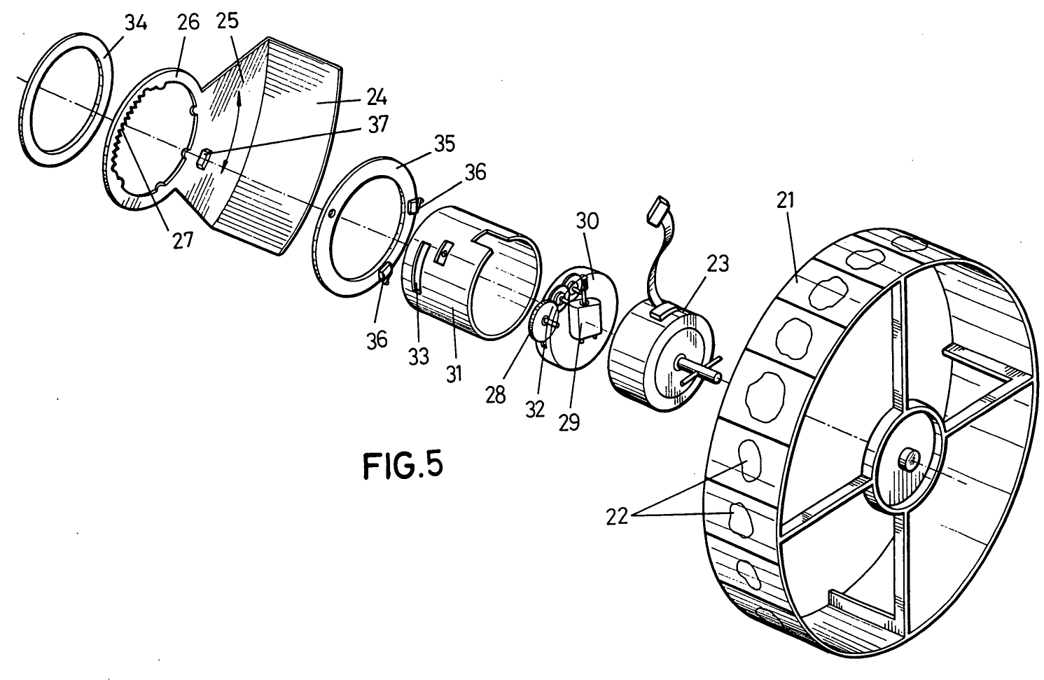

In the embodiment variant shown in FIG. 5, the stopper is equally intended for displays (21) materialized in a cylindrical roulette or drum, carrying and alignment of images (22) on its periphery and driven by an electric motor (23) coaxially assembled on it, and is materialized in a rectangular blind (24), having an arched profile, formally and dimensionally suitable so as to be placed outside and concentrically on the drum (21), hiding the images or figures (22) of the latter which are visible through the screen in normal conditions, for which purpose said blind is opaque, extending along one of its side edges on a radial arm (25), having a suitable length, which is finished off on its other end with a disc ring (26) through which it receives the rotational movement for rocking the blind or lid (24).

Said ring (26) incorporates a geared sector (27) on the inner edge thereof, which meshes with the output pinion (28) of a set of reducing gears, which in turn receives the movement from a micromotor (29) established on a disc shaped support (30) shield, having a diameter coinciding with the diameter of the main drive motor (23) of the drum (21), and which, like the latter, is intended to be housed in the cavity of a support materialized as a cylindrical capsule (31).

More specifically, the support (30) incorporates a slit (32) on its side wall, through which the output pinion (28) partially protrudes outwardly, a slit (32) that, in assembly situation for the support in the cavity of the cylindrical capsule (31), is facing another slit (33) existing on said capsule, specifically in the same area where it is coupled to it with the possibility of turning the ring (25), such that the output pinion (28) meshes with the geared sector (27) of said ring (26).

The described structure is complemented with a pair of washers (34-35) which frame the geared ring (26), which can optionally be fixed together and which in any case are fixed to the support capsule (31), one of these washers (35) having the end stops (36) which, with the collaboration of a stop (37) joined to the arm (25), control the micromotor (29) circuit to control in turn the angular shifting of the blind or lid (24) within the limits pre-established for that purpose.

It is thus achieved that the majority of the mechanism is housed inside the cylindrical capsule (31), having an inner diameter coinciding with that of the main drive motor (23) of the rotating display (21), such that only the geared ring (26) and the washers (34) and (35) are outside of it, which implies an scarce increase of diameter and, therefore, a very reduced volumetric occupation which in practice does not obstruct the assemble of the unit under any circumstance.

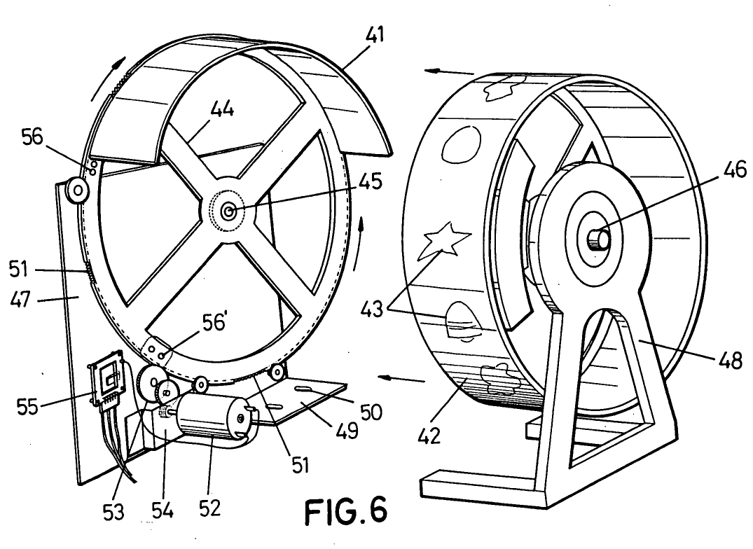

Finally, in the embodiment variant shown in FIG. 6, the stopper also incorporates the classic stopper lid (41), having a width at least coinciding with that of the roller (42) carrying the images (43) forming part of the combining game which permits the player to win a cash prize, images (43) which are sequentially visible by the player through the corresponding window of said display, established on the screen of the machine, also having the suitable length of said stopper (41) so as to totally hide said viewing window.

On one of its curved edges, the stopper (41) is joined to the periphery of the flywheel (44) assembled with rotational freedom on a shaft (45) which, in an assembled situation for the stopper, is coaxial with the shaft (46) of the roller (42), said shaft (45) being specifically assembled in turn with rotational freedom on a flat support (47) parallel to the support (48) of the roller (42), opposite the latter, and on one of its edges provided with an orthogonal bracing (49) with holes (50) for fixing it to the structure of the recreational machine.

The flywheel (44) incorporates a perimetral gearing (51) through which it receives the movement from a micromotor (52), with which a reducing transmission (53) collaborates, elements established on the support (47), with the collaboration of an auxiliary flat bar bridge (54).

The support (47) is also for the plate (55) carrying the control circuit of the motor (52), with the circuit a pair of end stops collaborate which are fixed to the periphery of the flywheel (44), with the possibility of positional adjustment, specifically with the collaboration of holes (56-56′) operatively made on the flywheel (44).

The limit switches, not shown in the drawing, can be magnets acting due to the Hall effect, they can be optocouplers, microswitches or any other means deemed suitable.

The integral gearing (51) of the flywheel (44) enables the shift of the stopper lid (41) to be 360°.

1. Stopper for displays for recreational machines, specifically for recreational machines provided with various displays capable of sequentially showing different figures through the screen of the machine, determining prize winning combinations, characterized in that it consists of an opaque blind (4) capable of covering the part of the display (1) appearing through the screen of the machine and which at the end of each play is susceptible to rocking or rotating to enable freely and directly visualizing said sector of the display, so that after the displays have stabilized, the figure of some of them participating in the winning line is kept hidden, and therefore the resulting combination is only partially visible, until the player makes a decision on the play to that respect.

2. Stopper for displays for recreational machines according to claim 1, characterized in that the blind (4) is associated to a rocking arm (5) finished off with a ring on its other end, assembled with rotational freedom on a support (10) preferably associated to the support of the main motor (3) of the display, a ring (6) provided with a geared sector (7) through which it receives the movement from an auxiliary micromotor (9) by means of a suitable set of reducing gears (8) established on said support (10) and capable of supplying said arm (5) with an angular movement suitable for the foreseen shift for the blind (4) between the stopping and non-stopping limit positions.

3. Stopper for displays for recreational machines according to previous claims, characterized in that when the auxiliary micromotor (9) is a conventional micromotor, two fixed end stops (11-11′), preferably microswitches, are established on said support, collaborating with the microswitches there is a stop (12) associated to the arm (5) of the blind (4) in order to limit the rocking movement of said arm in both directions.

4. Stopper for displays for recreational machines according to claims 1 and 2, characterized in that the micromotor (9) is a “stepper” motor which enables controlling its drive pulses and, therefore, the amplitude in the angular shift of the arm (5) associated to the blind (4).

5. Stopper for displays for recreational machines according to previous claims, characterized in that on its outer surface the blind (4′) incorporates additional figures (2′) that are complementary to the figures (2) present on the drum (1) or roller, as well as a window (13) which permits visualizing said figures of the drum (1) or roller, the number of said figures and windows being various in number and position.

6. Stopper for displays for recreational machines according to claim 1, characterized in that the blind (24) is associated to a rocking arm (25) finished off with a disc ring (26) with an inner gearing (27) upon which a drive motor (29) of the blind (4) acts, said motor (29) as well as its complementary group of reducing gears (28) housed on a support (30) like a circular shield, of a diameter coinciding with that of the main motor (23) and which, together with the latter, is housed in a support (31) materialized as a cylindrical capsule of an inner diameter coinciding with the outer diameter of the main motor (23) and of an axial height that is suitable for simultaneously receiving both elements, the output pinion (28) of the reducing group radially and partially emerging from this assembly, which meshes with the inner gearing (27) of the ring (26) finishing of the arm (25) of the blind (24).

7. Stopper for displays for recreational machines according to claim 6, characterized in that the output pinion (28) of the reducing group emerges to the outside of the support (30) through a slit (32) on its side wall, which operatively faces another slit (33) existing on the cylindrical capsule (31).

8. Stopper for displays for recreational machines according to claims 6 and 7, characterized in that the geared ring (26), assembled with rotational freedom on the cylindrical capsule (31) constitutive of the main support, is immobilized in an axial direction with regard to said capsule (31) with the collaboration of two washers (34-35) located on both sides of the geared ring (26) and duly fixed to the capsule (31), one of said washers (35) incorporating the end stops (36) for controlling the electric drive micromotor (29) of the blind (24), upon which a stop (37) acts that is established on the support arm (25) of the blind (24).

9. Stopper for displays for recreational machines according to claim 1, characterized in that the blind (41) is joined to the periphery of a flywheel (44) having a slightly over dimensioned diameter with regard to the roller or display (42) and intended to be laterally adapted to the latter in a coaxial arrangement, the shaft (45) of said flywheel being assembled with rotational freedom on a support (47) in turn parallel to and opposite to the support (48) of the complementary roller or display (42), provided with an orthogonal bracing (49) on one of its edges for the fixation thereof by means of screwing it to the structure of the machine or to the display (1) to which it serves.

10. Stopper for displays for recreational machines according to claim 9, characterized in that the flywheel (44) incorporates a perimetral gearing (51) through which it receives the movement from a micromotor (52), with or without interposing a reducing transmission (53), such that the shift of the blind (41) can reach 360°, said motor (52), its reducing transmission (53) and its control circuit (55) being assembled on the same support (47) as the flywheel (44), the latter incorporating suitably placed holes (56) on its periphery for assembling the end stops controlling the angular shift of the flywheel (44) and of the stopper blind (41) associated to it.

11. Stopper for displays for recreational machines according to claim 10, characterized in that the micromotor (52) is the “stepper” type.
